(19) United States
(12) Patent Application Publication
(10) Pub. No.: US 2012/0043677 A1
(43) Pub. Date: Feb. 23, 2012

(54) Method for Making a Combined Light Coupler and Light Pipe

(75) Inventors: Gregory P. Frankiewicz, Mayfield Heights, OH (US); Joseph D. Thaler, Mayfield Heights, OH (US); Chris H. Jenson, Twinsburg, OH (US)

(73) Assignee: Energy Focus, Inc., Solon, OH (US)

(21) Appl. No.: 13/216,233

(22) Filed: Aug. 23, 2011

Related U.S. Application Data
(60) Provisional application No. 61/375,939, filed on Aug. 23, 2010.

(51) Int. Cl. G02B 6/26

(52) U.S. Cl. 264/1.25

(57) ABSTRACT

A method for making a combined light coupler and light pipe comprises providing a mold with an elongated chamber having two ends and having an appropriate shape to form the combined light coupler and light pipe. The formed light pipe has an elongated shape. The formed light coupler has an inlet end for receiving light and an outlet end for transmitting light to the light pipe, and is shaped in such a way as to transform at least 70% of the light it receives into an appropriate angular distribution needed for total internal reflection within the light pipe. A cross-linkable polymer having a weight average molecular weight ranging from about 2,000 to about 250,000 daltons is provided. At least part of the chamber of the mold is filled and contacted with the polymer, which is then cross-linked, such that the formed light coupler and light pipe have a unitary construction.

### CROSS-REFERENCE TO RELATED APPLICATIONS

This application claims priority to U.S. Provisional Application No, 61/375,939 filed on Aug. 23, 2010, the disclosure of which is incorporated herein by reference.

### FIELD OF THE INVENTION

The lighting system relates to a method of making a combined light coupler and light pipe, are more particularly to such a method wherein the combined light coupler and light pipe may have dimensions exceeding 12 inches (30.48 cm) in length, which is typical for a ¼ inch (6.35 mm) diameter light pipe, or exceeding more than one inch (2.54 cm) in diameter.

### BACKGROUND OF THE INVENTION

A typical elongated lamp having a conduit through which light propagates by total internal reflection (TIR) comprises a light source, a light coupler that receives and conditions light from the light source for transmitting into a discrete, light pipe, such as a light pipe, where it propagates by TIR. Light-extraction means may be provided, if desired, on some length of the side of the light pipe for extraction light from the side of such rod. The coupling member may be generally governed by the laws of Etendue, relating to preservation of brightness of light. As is known, light propagation from one optical component to a discrete optical component may result in significant losses. For instance, light leaving the outlet surface of a light coupler enters may suffer a Fresnel reflection loss of about 4%, and light entering the inlet surface of a light pipe (e.g., light pipe) may suffer an additional Fresnel reflection loss of about 4%.

A unitary light coupler and light pipe, of limited size, in which the foregoing Fresnel reflection losses are avoided, has been sold in the U.S. more than one year ago. While such device may constitute prior art in the U.S., it may not constitute prior art in other countries. The limited size was about 6 inches (16.24 cm) and ¼ inch (6.35 cm) thick. Such a unitary system was made by injection-molding an optically clear thermoplastic resin to form the unitary light coupler and light pipe. However, such a method is limited by the size of the optical device that is molded. For example, if a light coupler and an light pipe is either too long (e.g., 12 inches [30.48 cm], which is typical for a ¼ inch [6.35 mm] light pipe) or too wide (bigger than one inch [2.54 cm] in diameter), then injection-molding becomes difficult and time-consuming, for various reasons. In addition to requiring increased molding cycle times, other difficulties include imperfections in the molded device, such as bubbles, which may occur due to the large amount of material that is injected, as well as internal stress resulting from differential rates of cooling, resulting in a diminution of desired optical properties.

However, with the amount of light available from LED light sources increasing over time as LED manufacturing improves, there is a need for larger or longer combinations of a light coupler and light pipe with increased efficiency, which cannot be reliably made by injection-molding thermoplastic resin.

### SUMMARY OF THE INVENTION

A preferred form of the invention provides a method for making a combined light coupler and light pipe. The method comprises providing a mold with an elongated chamber having two ends and having an appropriate shape to form the combined light coupler and light pipe. The formed light pipe has an elongated shape. The formed light coupler has an inlet end for receiving light and an outlet end for transmitting light to the light pipe, and is shaped in such a way as to transform at least 70% of the light it receives into an appropriate angular distribution needed for total internal reflection within the light pipe. A cross-linkable polymer having a weight average molecular weight ranging from about 2,000 to about 250,000 daltons is provided. At least part of the chamber of the mold is filled and contacted with the polymer, which is then cross-linked, such that the formed light coupler and light pipe have a unitary construction.

Beneficially, the foregoing method may provide for larger or longer combinations of a light coupler and light pipe luminaire with increased efficiency, which cannot be reliably made by injection-molding thermoplastic resin. Of course, the method can make small combinations of a light coupler and light pipe if desired.

### BRIEF DESCRIPTION OF THE DRAWING FIGURES

In the drawing figures, in which light reference numerals refer to like parts:

FIG. 1 is a side plan view of an LED lamp which couples light from a LED light source into a simple light pipe.

FIG. 2 is a side plan view of an example of an elongated LED lamp wherein where a light coupler and light pipe are formed and a single, integral component.

FIG. 3 is a simplified side plan view of a gravity fed mold in accordance with an embodiment of the invention.

FIG. 4 is a block diagram of a manufacturing step applicable to an embodiment of the invention.

FIG. 5 is a simplified side plan view of a further gravity fed mold in accordance with another embodiment of the invention.

FIG. 6 is a perspective view of another gravity fed mold in accordance with a further embodiment of the invention.

FIG. 7 is a side plan view of another gravity fed mold in accordance with another embodiment of the invention, in which part of the mold may remain clad onto the resulting combined optical coupler and light pipe.

FIG. 8 is a simplified side plan view of a gravity fed mold in accordance with another embodiment of the invention.

FIG. 9 is a fragmentary portion of a modification to the mold of FIG. 7.

FIG. 10 is a fragmentary view of a mold showing a removable portion for assisting in forming a light coupler.

### DETAILED DESCRIPTION OF THE INVENTION

The examples and drawings provided in the detailed description are merely examples, which should not be used to limit the scope of the claims in any claim construction or interpretation.

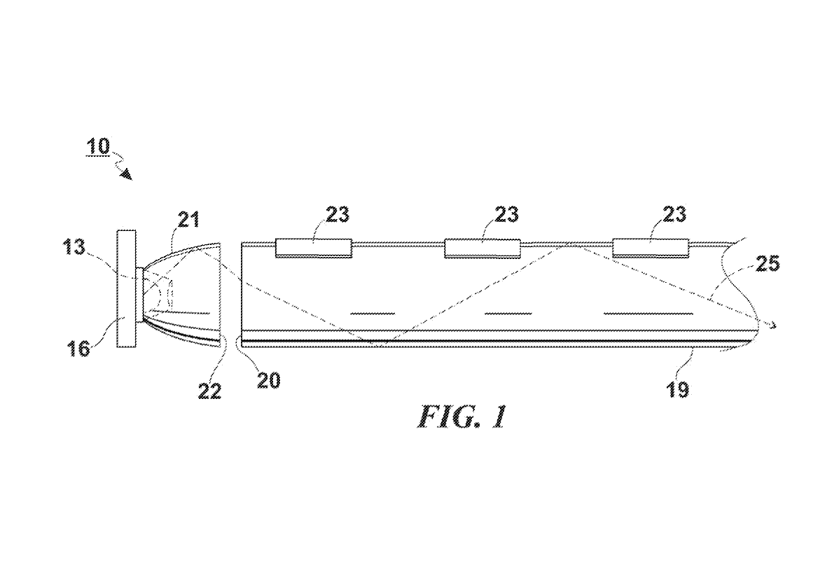

The elongated LED lamp 10 of FIG. 1 was a consideration of the present inventors in developing the presently claimed invention, and by itself is not believed to constitute prior art. LED lamp 10 is described first, for explaining an advantage of the claimed invention.

In FIG. 1, an elongated LED lamp 10 an LED light source 13, mounted on a heat sink 16, whose light is coupled into a light pipe 19 by a typically solid light coupler 21, as described below. Light pipe 19 may include light-extraction means 23, as described below, for extracting light from the side of the light pipe. In the absence of light-extraction means, the light pipe 19 transmits light from light coupler 21 to a distal end of the light pipe 19 (not shown). Further details of light pipes are disclosed in U.S. Pat. No. 7,163,326, the contents of which are fully incorporated herein by reference.

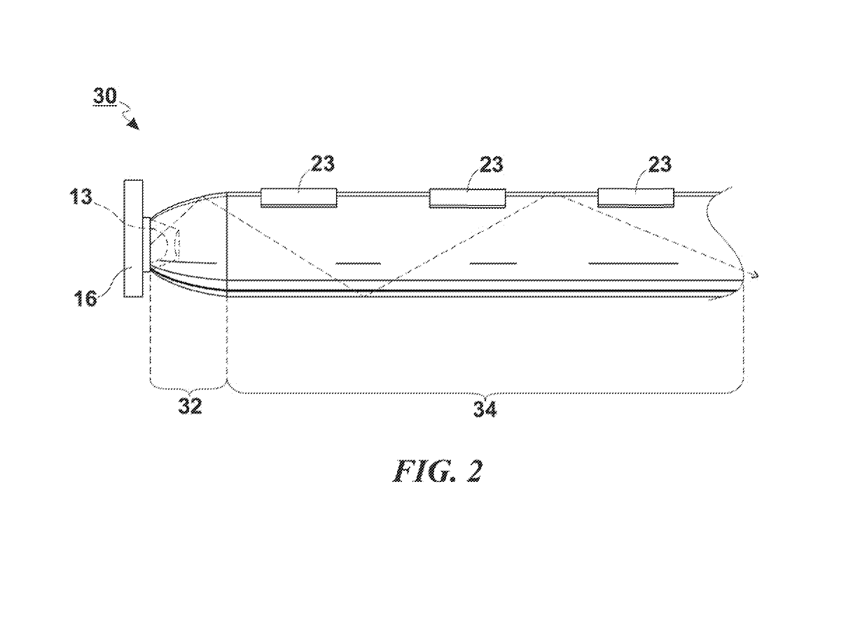

In the elongated LED lamp of FIG. 1, light such as light ray 25 exits outlet surface 22 of light coupler 21, and enters inlet surface 20 of light pipe 19. Each passage through outlet surface 22 and inlet surface 20 results in about a 4% loss of light due to Fresnel reflections. So, passage through surfaces 22 and 20 results in about 8% loss of light, which is undesirable. By eliminating the two surfaces 22 and 20 through forming the coupling member 21 and light pipe 19 as an integral and gaplessly continuous structure, as shown in FIG. 2, then an immediate gain in efficiency of about 8% may be realized.

### Combined Light Coupler and Light Pipe

In FIG. 2, an LED lamp 30 integrates into a combined, or unitary, structure, a light coupler 32, performing the same function as light coupler 21 in FIG. 1, with light pipe 34. This is preferably accomplished by forming both parts in a molding process, in the same mold, as further described below. The common LED light source 13 as between LED lamps 10 and 30 of FIGS. 1 and 2 generates the same amount of light, and the light couplers 21 and 32 still receive and couple the received light into the light pipes 19 and 34. However, in LED lamp 30 of FIG. 2, since there are no surfaces for the light to cross as the light exits the light coupler 32 and enters the light pipe 34, the overall efficiency will be about 8% higher than for the LED lamp 10 of FIG. 1 where LED lamps 10 and 30 share the same material and dimension.

Additionally, the LED lamp 30 of FIG. 2 has only two components, i.e., the integrated unitary unit having both the light coupler 32 and light pipe 34, and LED light source 30, instead of having three components as in FIG. 1. The reduction in the number of parts makes the LED lamp 30 of FIG. 2 will typically make it easier to manufacture, and be easier to mount and support the various parts of LED lamp 30, compared to LED lamp 10.

### Preferred Molding Method with Cross-Linkable Polymer

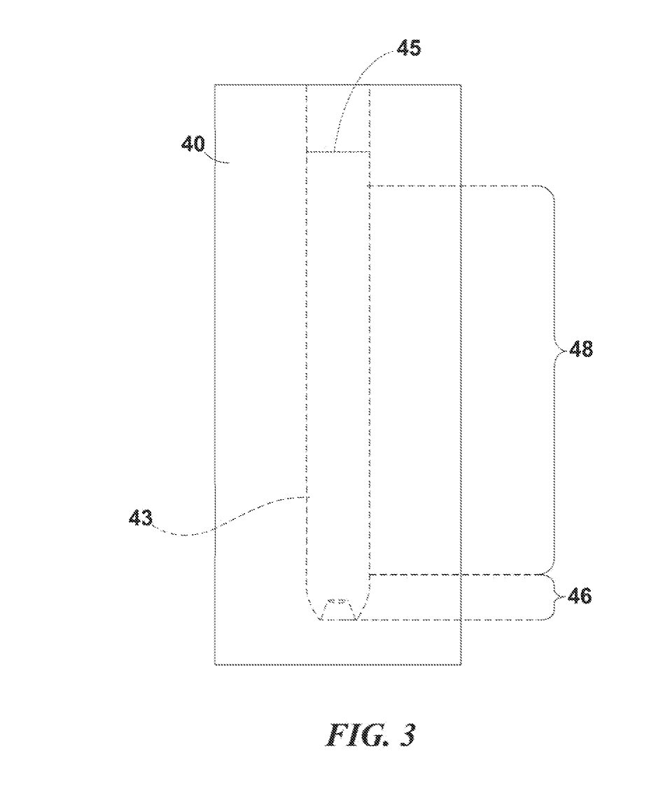

As shown in FIG. 3, a preferred molding method uses a gravity fed mold 40. Mold 40 has the an interior, elongated chamber 43 having the requisite shape along length 46 for forming a solid light coupler such as coupler 32 of FIG. 2, and also having the requisite shape along a further length 48 for forming a solid light pipe such as light pipe 34 of FIG. 2.

It is preferred to fill the mold 40 with a cross-linkable polymer, so as to avoid the shrinkage that typically occurs during the polymerization process. By “cross-linkable” is meant a polymer that is substantially free of cross-links, where the phrase “substantially free” takes into account experimental deviations understood by a person of ordinary skill in the art.

It is further preferred to use polymers having a low molecular weight, such as having a weight average molecular weight ranging from about 2,000 to about 250,000 daltons, which reduces shrinkage in the mold.

Suitable cross-linkable polymers should provide optical clarity in the finished product for at least a significant portion of the visible light spectrum. By optical clarity is meant herein that a 4 foot (122 cm) length of such polymer (e.g., in the form of a cylinder) would transmit at an output end at least 70% of impinging light at an input end over the visible spectrum of wavelengths. There may be some shifts in the light transmitted, where, for instance, less blue light is transmitted than red light. An even more suitable polymer is one where the foregoing percentage is 80%. Such suitable polymers include acrylic compositions, styrene, silicone compositions and polycarbonales, and combinations thereof.

Reference may be made to U.S. Pat. Nos. 5,406,641 and 5,485,541 to Bigley, Jr., et al. in regard to the concerns of using a cross-linkable polymer with a low molecular weight polymer to avoid shrinkage while being cured. The foregoing patent is incorporated herein in its entirety by reference. The present inventive method allows formation of larger diameter light pipes than the foregoing Bigley, Jr., et al. patents teach. For instance, the present inventive method contemplates light pipe diameters that may exceed one inch (2.54 cm) in diameter.

### Rigidity of End Product

It is preferred that the end product, that is, an integral light coupler and light pipe, be rigid, by which is meant that at 20 degrees Celsius the combined coupler and light pipe has a self-supporting shape such that it returns to its original or approximately original (e.g., linear or curved) shape after being bent along a main path of light propagation through the combined coupler and light pipe. Such ability to bend may assist in installation of the combined light pipe and coupler.

An exemplary polymer composition that would give the desired rigidity would be a polymer created from 100% methyl methacrylate monomer. This composition could be modified with the addition of up to 10% butyl methacrylate and still give the required rigidity. Other polymer compositions such as polycarbonate and polystyrene would give the desired rigidity. However, those polymer formulations may not produce the desired optical clarity as can be obtained with polymers composed of acrylic monomers.

The polymers disclosed in the two above-cited Bigley, Jr., et al. patents may be used, but are suited instead for providing flexibility in the finished product. Usually, the light coupler and light pipe product described herein is desirably rigid so that it can replace a convention fluorescent lamp, for instance.

### Example of Making a Cross-Linkable Polymer Using Acrylic Monomers

An exemplary composition of a mixture of monomers used to make a cross-linkable polymer for being molded into a combined light coupler and light pipe consists of 95% methyl methacrylate and 5% methoxyacrylpropyl trimethoxysilane. Based on this mix, 0.1% (based on the weight of the monomers) of VAZO-brand 52 polymerization initiator, available from E. I. Du Pont De Nemours and Company, Wilmington, Del. USA, is added to the mix along with 1.0% (based on the weight of the monomers) of octylmercaptan. These components are mixed then heated to 9° C. for 1 hour creating cross-linkable polymer. At the end of one hour, the mixture is held under vacuum (29 mm Hg) and stirred to remove unreacted monomeric methyl methacrylate and octylmercaptan. After a majority (>90%) of the unreacted methylmethacrylate has been removed, 0.1% (based on the weight of the monomers) water is added along with 10 ppm (based on the weight of the monomers) di-butyl tin diacetate. The resulting polymer can be placed in a mold as described herein and heated to 80 degrees Celsius for 5 days to undergo curing by cross-linking, to provide a rigid polymer, as defined herein.

Once the cross-linkable polymer has been introduced into the mold 40, by filling and contacting at least part of the chamber 43 of mold 40 preferably to a fill line 45, for instance, the polymer is then cross-linked. The reason that preferable fill line 45 is higher length 63 of the chamber, for formation of a light pipe, is explained below. Cross-linking may be achieved through a thermal process, or through a photo-polymerization process, or though water moisture cure process, or other processes known to a person of ordinary skill in the art.

Crosslinking of the polymer chains can be accomplished by including in reactive materials such as diethylene glycol dimethacrylate in the polymer backbone, functionalizing polymers chains to include reactive urethane or epoxy groups that can react with similar neighboring functionalized polymer chains or by using photoreactive free radical polymerization initiators and free radical active crosslinking units such as diethylene glycol dimethacrylate or other multi-free radical active monomers.

Once the cross-linkable polymer in mold 40 has become cross-linked, the resulting product is removed from the mold. This may be facilitated with mold release agents, which can be used with any of the molds described herein, as will be apparent to those of ordinary skill in the art. Mold release agents can include fatty acid derivatives such as fatty acid esters, such as disclosed in U.S. Pat. No. 7,829,651, the disclosures of which is incorporated herein by reference. The cured end product in the mold 40 is extracted by pulling upwardly on the end product.

Vent holes (not shown) are preferably provided to allow air to enter the chamber 43 as the end product is being pulled upwardly. Such vent holes could also be used to insert pressurized air into the chamber 43 to assist in removal of the end product. The vent holes are preferably sealed before the end product is cured. Finally, a wire or other material (not shown) could be suspended into the top portion of the end product while the end product is curing (i.e., being cross linked), so as to be permanently embedded in the top of the end product. Such a wire, etc., then can be easily gripped for assisting in pulling out the cured end product.

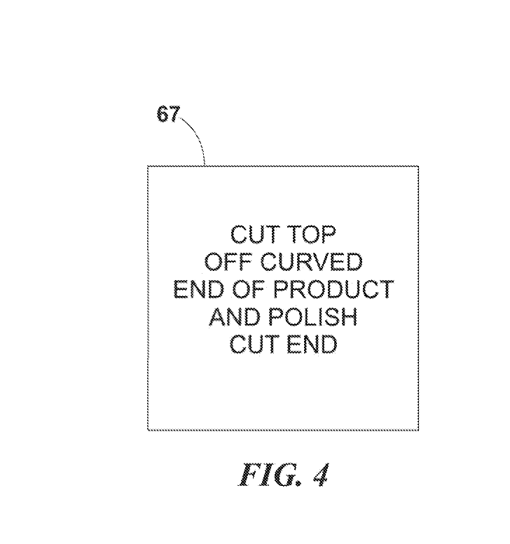

FIG. 4 shows a preferred step, at block 67, of cutting off the top-shown end in FIG. 4 of the end product, which preferably constitutes a combined light coupler and light pipe and an additional portion above length 48 and below preferable fill line 45. Block 67 further indicates polishing the cut end of the end product, preferably to provide an optical finish, by smoothing the end of the cut end of the light pipe to provide a polished glass-like surface, or to provide a near optical finish. The steps in block 67 may be desirable if a wire, etc., for removing the end product has been embedded in the upper portion of the end product, or if the upper portion of the end product does not have an optically appropriate end for other reasons.

Examples of materials for forming mold 40 of FIG. 3 include highly polished stainless steel, aluminum or other suitable metals. Mold 40 may also be composed of solid plastic materials such as acrylic, polycarbonate, silicone or more ideally of a fluoropolymer such as TEFLON-brand polytetrafluoroethylene (PTFE), supplied by E. I. du Pont de Nemours and Company, of Wilmington, Del. USA. In any case, the chamber (e.g., 43, FIG. 3) of any mold described herein may be coated, if necessary, to provide an interior surface of material such as fluorinated ethylene propylene (FEP) that allows for easy release of an end product.

### Other Molds

As one alternative to mold 40, FIG. 4 shows a mold 50 having a chamber 53, which may be partially filled and contacted with cross-linkable polymer preferably to a fill line 56, for the same purposes as described above for fill line 45 in FIG. 3. Length 61 of chamber 52 is used to form a light coupler differing from light coupler 32 of FIG. 2 by having a non-monotonic profile to its cross section along a central path of light propagation through the coupler. In other words, a light coupler formed by mold 50 increases in diameter and then decreases in diameter from an, inlet end, for receiving light, to an outlet end, for transmitting light to an integrated light pipe. In order to be able to remove the end product, mold 50 has a mold halve 51 and a mold halve 52, which can be separated from each other once the end product has cured; that is, has become suitably cross-linked. The mold halves can be joined together by any suitable means, such as with nuts and bolts. As used herein a “mold halve” means a mold portion, and not that every portion of one mold halve is the same as in the other mold halve.

In one example for removing the end product, the two halves 51 and 52 of the mold 50 can meet in a joint area such that openings (not shown) between the mold halves can accommodate a device such as a flat screw driver. Such openings (not shown) to assist in splitting apart the mold halves may be located at various points around the mold in order to provide multiple points to pry the mold apart. Other apparatuses or techniques that will be routine to a person of ordinary skill may also be used to separate the mold halves.

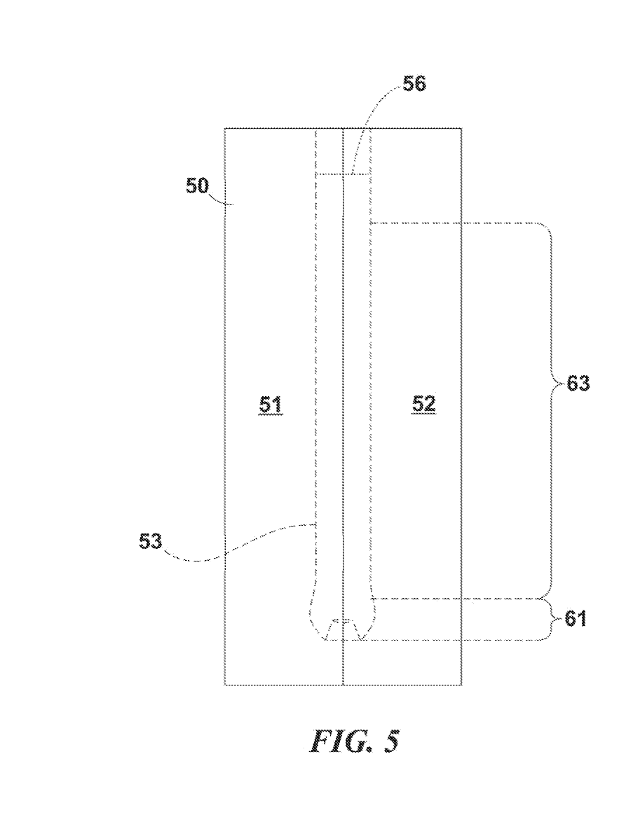

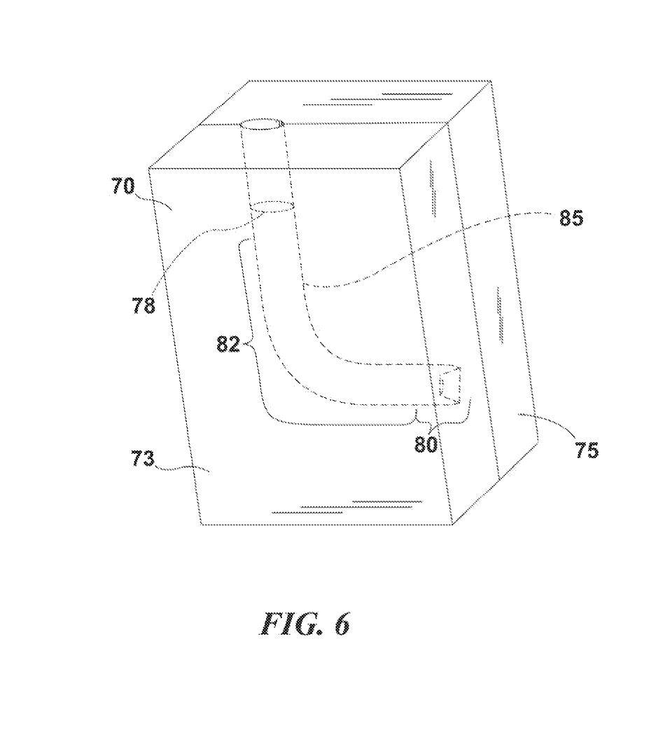

FIG. 6 shows another gravity fed mold 70, which, like mold 50 of FIG. 5, is a two-piece mold, having a mold halve 73 and a mold halve 75. A preferred fill line 78 corresponds to preferred fill line 56 of two-piece mold 50 (FIG. 5) and lengths 80 and 82 of a mold chamber 85 correspond to lengths 61 and 63 of mold 50, except that length 82 of mold 70 has a 90 degree or other bend so as to form a combined light coupler and light pipe wherein the light pipe is curved.

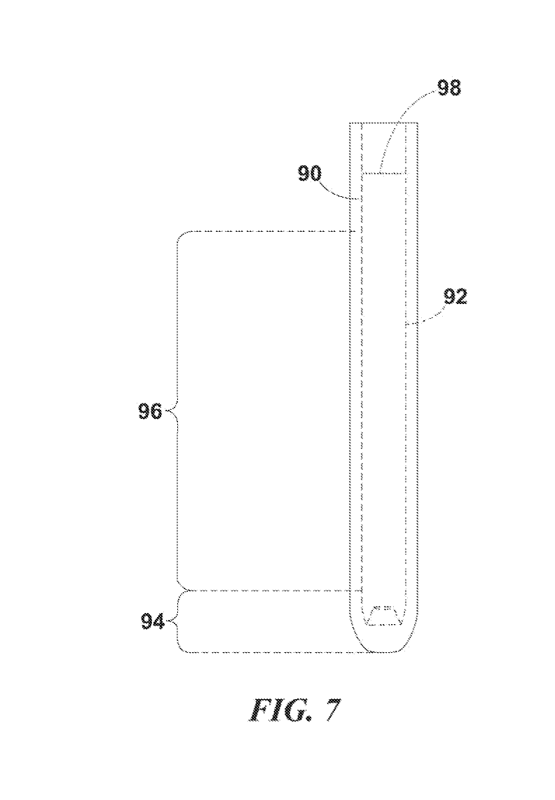

FIG. 7 shows a one-piece gravity fed mold 90, preferably made from a material having a lower refractive index than the combined light coupler and light pipe to be molded. Mold 90 preferably constitutes a single, blow-molded polymer, such as fluorinated ethylene propylene (FEP). The single blow-molded mold 90 of FEP, for instance, may resemble a plastic soda bottle but have the shape of the light coupler and preferably also the shape of the combined light pipe.

Mold 90 has a chamber has lengths 94 and 96, which correspond to lengths 46 and 48 of mold 40 of FIG. 3, and whose description is applicable to lengths 94 and 96. Once chamber 92 of mold 90 has been at least partially filled, for instance, to preferable fill line 90, with cross-linkable polymer, and the such polymer has been cured (i.e., cross-linked), part of the mold 90 remains in protective contact over the combined light coupler and light pipe, for serving as both a protective cover and a lower index of refracting cladding. Any portion of the light coupler as to which extraction of light from the side of the light pipe is desired would require removal of the cladding. Typically, part or all of the mold portion that forms the light coupler may be removed.

Alternatively, mold 90 may be cut open and discarded after a combined light coupler and light pipe have been formed. In this case, the index of refraction of the mold is irrelevant since the mold will be discarded.

An advantage of mold 90 is that it is relatively inexpensive, so that a multiplicity of such molds can be economically used simultaneously. This situation arises where cure times for the cross-linkable polymer for forming a combined light coupler and light pipe range in days, as is true for some techniques of cross-linking. This is beneficial to increase production of end products while minimizing the overall cost of multiple molds.

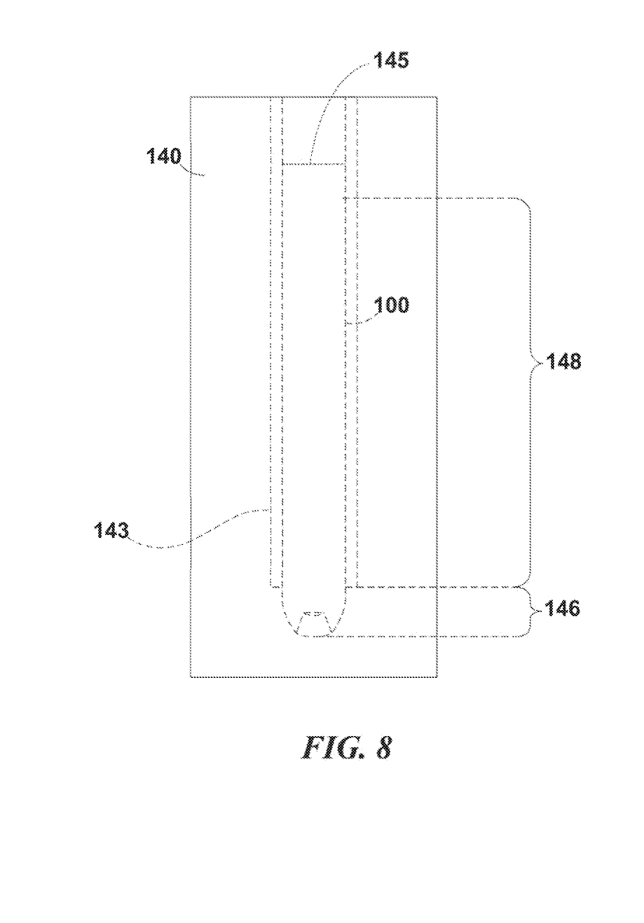

Alternatively, if a suitable blow-molded polymer (e.g., mold 90) cannot replicate the desired shape of a light coupler, for example, then an FEP sleeve 100, preferably of extruded construction, may be used with a modification of mold 40 of FIG. 3, shown as mold 140 of FIG. 8. Mold 140 has an enlarged chamber 143 in its length 148 for forming a light pipe, and also above length 148. The enlarged portion of chamber 143 accommodates FEP sleeve 100, while assuring that the junction between the end product light coupler and light pipe is smooth. FEP sleeve 100 is inserted into chamber 143 before filling to a desired level and contacting the chamber, with the sleeve in the chamber as shown, with cross-linkable polymer. After the polymer is cured by cross-linking, at least part of the FEP sleeve may remain in place on the resulting light pipe.

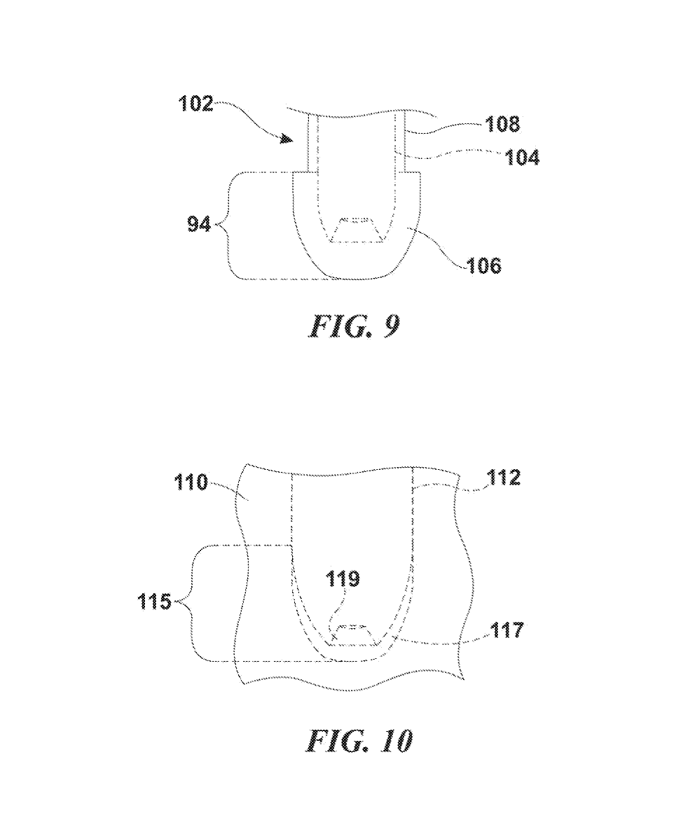

FIG. 9 shows an alternative to mold 90 of FIG. 7, wherein a length 94 of chamber 104 is comprised of a removable and reusable mold section 106. Mold section 106 can be sealed to mold section 108 by various techniques, such as by mechanically pressing together mold sections 106 and 108, with or without a gasket (not shown) between such sections. In this way, mold 102 can be used in the same way as mold 90 described above, except that the mold section 106 is reusable. Mold section 106 may be formed from any of the various materials mentioned above for forming mold 40 of FIG. 3, by way of example. In this embodiment, intricate or unusual shapes for the light coupler can be formed by removable mold section 106, which would be beneficial especially if blow molding of mold section 106 is difficult. Reusable mold section 106 may be made from plastic or a metal coated with plastic, wherein the plastic properties of such plastic or other polymer can be used to create a seal with mold section 108. An exemplary plastic is FEP.

As shown in FIG. 10, a mold 110 has a mold chamber 112 with a length 115 for formation of a light coupler portion of a combined light coupler and light pipe. A removable mold portion 117, of PTFE as described above, for instance, is used for assuring a higher degree of precision in molding the light coupler than would be possible without using such removable portion. This may be due to intricate geometry in region 119 of the mold, in which a recess in the light coupler is provided for accommodating light received by an LED light source, for instance. Use of the plastic properties of PTFE or another polymer for removable mold portion 117 can assist in making a seal to the remaining portion of mold chamber 112 for forming a light pipe.

The removable mold portion 117 may be used in all applicable molds.

Other types of molds than gravity fed molds may be used. For instance, molds in which a cross-linkable polymer is pressure fed may be used, but would typically be more complicated in construction and thus more costly than gravity fed molds.

### Light Pipe

A portion of the optical system that has not been described as a light coupling portion may be represented as a light pipe. For example, the non-optic component may function solely as the light pipe as large core plastic optical fibers are known to operate and transport light to some remote location where the fibers may either illuminate a target directly or feeds some fixture that creates a spot of some sort or feeds a side light distribution arrangement or some other general illumination or decorative fixture.

In another example, the portion of the molded cross-linked component may also act directly as a side-emitting distribution arrangement where some extraction means are applied along the length of the arrangement and light is extracted along the length. The non-optic section may also have multiple portions which generally act as a LCPOF light pipe and at least portion of the light pipe that acts a side-light distribution component. The FEP mold may be left on one section or both sections or neither of the sections of the system, depending on the requirements of the application.

In another example, the unitary system need not be formed in a linear fashion. For example, the system may include a mostly rigid optical component, where there is some flexibility to aid in the installation, but may be preformed with specific bends such that installation may be easily occur without sacrificing efficiency.

Further discussion of light pipes are disclosed in U.S. Pat. No. 7,163,326, the contents of which are incorporated herein by reference.

### Non-Imaging Light Coupler

Normally, the light coupler only transforms light from a light source into the proper angular distribution required by the light pipe. The light pipe normally only transports light down its length (via total internal reflection), delivering the light to the end opposite the light source. Also, the light-extraction means only extracts light transverse to the length of the light pipe; it does not collect light from a light source or perform any angular transformation of the light.

Regarding the light coupler, its interiorly-directed reflective surface is normally the primary device for receiving light from a light source. It then transmits that light toward a light-receiving portion of a light pipe, which is discussed in later paragraphs. This reflective surface is typically specular if the light coupler is hollow, or of the TIR-type if the light coupler is solid, where TIR means total internal reflection.

The rules of non-imaging optics govern the configuration of the light coupler at least approximately. As known in the art, the rules of non-imaging optics are concerned with the optimal transfer of light radiation between a source and a target. In contrast to traditional imaging optics, non-imaging techniques do not attempt to form an image of the source; instead, an optimized optical system for radiative transfer from a source to a target is desired.

The two design problems that non-imaging optics solves better than imaging optics are as follows. First, (1) concentration—maximizing the amount of energy applied to the target (as in solar power, for instance, “collecting radiation emitted by high-energy particle collisions using the fewest number of photomultiplier tubes”). Second, (2) illumination—controlling the distribution of light, typically so it is “evenly” spread over some areas and completely blocked from other areas (as in automotive headlamps, LCD backlights, etc.).

Typical variables to be optimized at the target include the total radiant flux, the angular distribution of optical radiation, and the spatial distribution of optical radiation. These variables on the target side of the optical system often must be optimized while simultaneously considering the collection efficiency of the optical system at the source.

Typically, a light coupler at least approximately governed by the rules of non-imaging optics has a profile that changes from the inlet end toward the outlet end to condition the angular distribution of light provided to a rod-shaped light pipe. That is, as light propagates through the light coupler, its angular distribution changes.

In addition, the interior surface of a solid light coupler may be configured to aid in the conditioning of light provided to a rod-shaped light pipe.

This change in the angular distribution of light conditions the light for distribution by the light pipe. Three examples are as follows. First, (1) the light may be conditioned to reduce the angular distribution of light to be significantly below the numerical aperture or acceptance angle of an light pipe member so that it propagates along the entire length of the light pipe member and is distributed out the opposite end. In this example, the member does not distribute light from its side, so it is not called a side-light emitting member.

In a second example (2), the angular distribution of light leaving the light coupler can be higher but closer, or even beyond, the numerical aperture (NA) of the distribution arrangement. In this case, the light leaving the light coupler with a higher angular distribution will see a greater number of interactions with the sides of the distribution arrangement thereby increasing the opportunity for distribution out the side of the distribution arrangement over a shorter distance.

In a third example (3), the profile of the light coupler changes so that the light leaving the light coupler is not only conditioned to cause the angular distribution to be within an intended NA, but also is conditioned to cause the light to be uniformly distributed among a greater number of angles. In this case, at least approximately governed by the rules of non-imaging optics, the profile of the light coupler will typically grow in size and then decrease as it approaches and reaches the distribution arrangement. Because the resulting light is conditioned so that light is present at a multitude of angles, light with higher angles will have more interactions with the side of the distribution arrangement and will be distributed over shorter distances, and light with lower angles will see fewer interactions so will be distributed over longer distances. The result may be a more uniform distribution out of the distribution arrangement along its entirety.

With respect to the light coupler, the coupling member can have an increasing cross-sectional area from a light coupling inlet end and a light coupling outlet end. The change in area for the light coupler can be of a non-monotonic function, for example, a compound parabolic curve. The increase in cross-sectional area of the light coupler may follow the pattern disclosed in U.S. Pat. No. 6,219,480, the disclosure of which is incorporated herein by reference. More specifically, the cross-sectional area of the light coupler increases in a continuous manner, where “continuous” means that the cross section at a point along an axial length transitions to a next point without any substantial discontinuities.

Alternatively, the cross-sectional area of the light coupler can increase and decrease in a continuous manner, where “continuous” means that the cross section at a point along an axial length transitions to a next point without any substantial discontinuities.

A “non-imaging” coupler, as used herein, tolerates minor manufacturing imperfections while retaining substantially the full functionality of an ideally formed non-imaging coupler.

### Light Pipe

A “light pipe” as used herein preferably comprises an elongated rod. By “elongated” is meant being long in relation to width or diameter, for instance, where the “long” dimension can be both along a straight path or a curved path.

One end of the light pipe receives light from an associated light coupler. The elongated rod has an elongated sidewall and light-extraction means may be placed along at least part of the elongated sidewall for extracting light through the sidewall and distributing said light to a target area. At least the part of the light pipe having light-extraction means is preferably solid, although there may exist in the light pipe small voids caused by manufacturing processes, for instance, which have insubstantial impact on the side-light light-extraction and distribution properties of the light pipe.

A “light pipe” as used herein has a cross section along a main axis of light propagation through the pipe that is more round than flat. For example, the minimum cross-sectional dimension is preferably more than 50% of the maximum cross-sectional dimension. In a preferred embodiment, the cross-section of the light pipe is substantially circular.

### Light-Extraction Means

Now specific examples of the light-extraction means will be discussed. Light-extraction means may be of various types whose selection will be routine to those of ordinary skill in the art. For instance, three types of light-scattering means are disclosed in U.S. Pat. No. 7,163,326, entitled “Efficient Luminaire with Directional Side-Light Extraction,” assigned to Energy Focus, Inc. of Solon, Ohio. In brief, these three types are (1) discontinuities on the surface of a light distribution arrangement or light pipe, (2) a layer of paint on the surface of a light pipe, and (3) a vinyl sticker applied to the surface of a light pipe.

In more detail, (1) discontinuities on the surface of a light pipe may be formed, for instance, by creating a textured pattern on the light pipe surface by molding, by roughening the light pipe surface with chemical etchant, or by making one or more notches in the side of a light pipe.

In another example, the light-extraction means may comprise a layer of paint exhibiting Lambertian-scattering and having a binder with a refractive index about the same as, or greater than that of, the core. Suitable light-extraction particles are added to the paint, such as titanium dioxide or many other materials as will be apparent to those of ordinary skill in the art. Preferably, the paint is an organic solvent-based paint. In yet another example, the light-extraction means may comprise vinyl sticker material in a desired shape applied to the surface of the light pipe. Appropriate vinyl stickers have been supplied by Avery Graphics, a division of Avery Dennison of Pasadena, Calif. The film is an adhesive white vinyl film of 0.146 mm, typically used for backlit sign.

In another example, the light-extraction means may be continuous, intermittent, or both, along the length of a light distribution arrangement, for instance. An intermittent pattern is shown in the above-mentioned U.S. Pat. No. 7,163,326 in FIG. 15A, for instance. To assure that the light-extraction means appears as continuous from the point of view of the observer in a target area to be illuminated, the target area should be spaced from the light pipe in the following manner: the spacing should be at least five times the length of the largest gaps between adjacent portions of paint or other light-extraction means along the main path of TIR light propagation through the light pipe.

Additionally, the foregoing light-extraction patterns may be of the specular type, scattering type, or a combination of both. Generally, a scattering extractor pattern for light on an elongated light pipe tends to provide light onto a target area, along the length of the light pipe, with a moderate degree of directional control over the light in the length direction. In the direction orthogonal to the length, the scattering extractor pattern density and the cross sectional shape of the elongated light pipe provide a smooth target distribution that is free of localized spatial structure but still provides good directional control. Scattering extractor patterns are relatively insensitive to fabrication errors.

In contrast, as used herein, a specular extraction pattern can provide light along the length of a light pipe with more localized control than can a scattering extraction pattern.

The following is a list of reference numerals and associated parts as used in this specification and drawings:

### REFERENCE NUMERAL

10 Elongated LED lamp
13 LED Lamp
16 Heat sink
19 Light pipe
20 Inlet surface
21 Light coupler
22 Outlet surface
23 Light-extraction means
25 Light ray
30 LED lamp
32 Light coupler
34 Light pipe
40 Gravity fed mold
43 Chamber
45 Fill line
46 Length
48 Length
50 Gravity fed mold
51 Mold halve
52 Mold halve
53 Chamber
56 Fill line
70 Gravity fed mold
73 Halve
75 Halve
78 Fill line
80 Length
82 Length
85 Chamber
90 Gravity fed mold
92 Chamber
94 Length
96 Length
98 Fill line
100 Sleeve
102 Mold
104 Chamber
106 Mold section
108 Mold section
110 Mold
112 Chamber
115 Length 117 Removable portion
119 Region
140 Gravity fed mold
146 Length
148 Length

As will be appreciated from the foregoing description, preferred forms of the present invention can produce combined light coupler and light pipe that is greater than about 12 inches (30.48 cm) in length, which is typical for a ¼ inch (6.35 mm) light pipe, or wider than about 1 inch (2.54 cm) in diameter.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method for making a combined light coupler and light pipe, comprising:
a) providing a mold with an elongated chamber having two ends and having an appropriate shape to form the combined light coupler and light pipe;
b) the light pipe having an elongated shape;
c) the light coupler having an inlet end for receiving light and an outlet end for transmitting light to the light pipe; the light coupler being shaped in such a way as to transform at least 70% of the light it receives into an appropriate angular distribution needed for total internal reflection within the light pipe;
d) providing a cross-linkable polymer having a weight average molecular weight ranging from about 2,000 to about 250,000 daltons;
e) filling and contacting at least part of said chamber of the mold with the polymer; and
f) cross-linking the polymer within the mold, such that the formed light coupler and light pipe have a unitary construction.

2. The method of claim 1, further comprising releasing the light coupler and light pipe formed from said cross-linking, and cutting and polishing the end of the light pipe.

3. The method of claim 1, wherein the combined light coupler and rod is rigid after cross-linking.

4. The method of claim 1, wherein the mold is a gravity fed mold in which the chamber is sealed at a lower end proximate to a portion of the chamber in which the light coupler is formed.

5. The method of claim 1, wherein said polymer is selected such, when cured and in the form of a cylinder of four foot (122 cm) length, it transmits from a first end of the cylinder to a second end of the cylinder at least 70% of received light over the visible spectrum of wavelengths.

6. The method of claim 1, wherein:
a) the portion of the mold for forming the light pipe comprises a polymer having a lower index of refraction than the resulting light coupler of unitary construction; and
b) at least part of the mold remains on the light pipe to provide a lower index of refraction cladding layer on the light pipe.

7. The method of claim 6, wherein the polymer for forming the mold is extruded.

8. The method of claim 1, wherein:
a) the entire portion of the mold including the chamber comprises a blow-molded polymer having a lower index of refraction than the resulting light coupler of unitary construction; and
b) at least part of the mold remains on the light pipe to provide a lower index of refraction cladding layer on the light pipe.

9. The method of claim 1, wherein the entire mold is removed after cross-linking by cutting the mold.

10. The method of claim 1, wherein the mold includes a removable and reusable mold portion for formation of at least part of the light coupler.

11. The method of claim 1, wherein the shape of the portion of the chamber which forms the light coupler has a cross section, along a central path of light propagation from an inlet end to an outlet end, that increases from a first cross sectional area to a maximum cross sectional area and then decreases in cross section to final cross sectional area larger than said first cross sectional area.

12. The method of claim 1, wherein the shape of the portion of the chamber which forms the light coupler results in a non-imaging light coupler.

13. The method of claim 1, wherein the light pipe has a cylindrical shape.

14. The method of claim 1, wherein the light pipe has first and second ends; and further comprising forming a light-extraction means on a side surface of the light pipe, between the first and second ends.

15. The method of claim 1, wherein the inner surface of the elongated chamber comprises a fluorinated ethylene propylene material.
